(19) United States
(12) Patent Application Publication
(10) Pub. No.: US 2005/0081937 A1
(43) Pub. Date: Apr. 21, 2005

(54) Piping for abrasive slurry transport systems

(76) Inventors: Steven L. Wilmeth, Longview, TX (US); Robert B. Anderson, Richland Center, WI (US); John R. Pechan, St. Charles, IL (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 10/688,752

(22) Filed: Oct. 17, 2003

(51) Int. Cl. F16L 9/14

(52) U.S. Cl. 138/143; 138/146

(57) ABSTRACT

A section of piping for use in transporting abrasive slurries which has improved abrasion resistance is shown. The piping has a tubular metal body with an exposed exterior surface and a generally cylindrical internal surface. The internal surface of the tubular metal body is uniformly plated with a deposit of chromium to give the section of piping a hard chromium case which resists abrasion. The deposit of chromium is applied by exposing the internal surface of the tubular metal body to an aqueous electrolyte solution at a current density and at a plating temperature sufficient to form a chromium deposit of desired thickness on the internal surface.

### BACKGROUND OF THE INVENTION

1. Cross Reference t Related Applications:

The present application is related to the copending application of Steven L. Wilmeth, Robert B.

Anderson and John R. Pechan entitled “Piping For Concrete Pump Systems”, filed concurrently herewith.

2. Field of the Invention:

The present invention relates generally to piping for transporting abrasive materials and to a chrome plating process for depositing a chromium deposit of desired thickness on the internal diameter of such piping.

3. Description of the Prior Art:

A variety of applications exist in industry for pumping abrasive materials. One such application is for pumping concrete in the various construction industries. High-grade concrete is typically pumped from the truck mixer to its final location. Delivery of this type maintains a uniform distribution of the concrete aggregate and sometimes lowers labor costs. The average concrete pump consists of two cylinders that function alternately to maintain a smooth flow. They discharge into a system of piping to transfer the concrete to its final location.

The concrete pumping industry has developed a standard length pipe section for the assembly of concrete pumping distribution lines. In the United States, this is typically a 10 foot length. Such pipe sections are formed with end shoulders defining outwardly projecting members for interconnection with standard couplings. Concrete pumping is a very high pressure environment. Pressures of 2000-3000 psi are typically encountered and even higher transient pressures may be encountered. Concrete pumping is also a very harsh environment. The system operates in an environment including airborne foreign matter and other contaminants in addition to the concrete itself which is a very abrasive and damaging material. The piping used in such applications at the present time is either ordinary steel pipe with special couplings; a pipe with the inside hardened to reduce wear; or a hard tube inside another tube. The ordinary steel pipe has an effective service life for about 15,000 yards of concrete pumped through the piping and the hardened piping lasts for about 35,000 yards of pumped concrete.

Modem concrete delivery systems are often packaged in the form of a mobile pump unit provided with an adjustable boom structure for distributing of the concrete within an expanded area adjacent the location of the mobile unit. Mobile pumping units are shown, for example, in U.S. Pat. No. 3,860,175 which issued on Jan. 14, 1975 and U.S. Pat. No. 3,918,749 which issuedNov. 11, 1975 and more recently in U.S. Pat. No. 4,640,533 which issued Feb. 3, 1987. A variety of commercially available mobile pumping units are available from Schwing America, Inc. of St. Paul, Minn., and from other suppliers. Mobile units generally include various connecting pipes including vertical and horizontal disposed pipes connecting a supply hopper to a concrete distribution line. An extendable multi-section boom structure is mounted for extension of the pipe line system and particularly the discharge pipe at the drop location within specific distances of the mobile unit.

The vertical and horizontal pipes are interconnected with appropriately located coupling units to permit location and orientation of the boom for proper location of the discharge end of the pipe. All of the above described types of concrete piping require the use of piping materials which are highly abrasion resistant. Generally, this requires an inner wall of a very hardened metal. However, there are limits upon the types of metals which can ultimately be used. For example, because of the high pressures encountered, concrete pumping requires a pipe having a very high tensile strength to operate satisfactorily over long periods of time. Additionally, it would be advantageous to be able to provide a pipe having improved abrasion resistance which did not add greatly to the weight characteristic of the pipe. Even more advantageously, a need exists for an improved piping which exhibits improved abrasion resistance for concrete pumping applications, which piping has a reduced wall thickness and is therefore lighter in weight. Weight impacts the distance that the piping boom is ultimately able to extend. In the case of fixed piping installations, weight impacts the amount of piping which can be hauled to a job site.

Another application for transporting abrasive materials is in the mining industry. Steel piping is widely used in different phases of the mining industry to convey, for example, the product ore and tailing slurries as well as to recycle debris back to the mining area. Slurries are a mixture of solid particles in a liquid medium. Steel piping is also used for backfilling the mine excavation areas by utilizing sand fill, classified tailings, or paste fill. Steel piping is also used in the mining industry as drop shafts for conveying product from high elevations.

Various metallurgical and material enhancements have been used in an attempt to transform steel pipe into high strength and abrasion resistant piping for use in these types of mining operations. These enhancements include hardening of the interior pipe wall, as by cold working or heat treating, as well as utilizing pipe wall materials of varying chemistries and types. For example, a layer of wear tiles is sometimes used in an attempt to protect the inside surfaces of the pipes. Also, other attempts have included the use of rubber and poly lined pipe, double wall pipes and bimetallic pipes.

Each of these proposed solutions has its advantages and its disadvantages, however, both in the manufacturing processes as well as in their application for slurry transport of abrasive materials. As will be apparent from the description which follows, the process of the present invention overcomes many of these disadvantages.

### SUMMARY OF THE INVENTION

The present invention has as its object to provide piping for pumping abrasive materials which exhibits improved abrasion resistance, much longer life, easier cleaning after use, and which may have a thinner wall which is therefore lighter in weight than the piping of the prior art. A section of piping is provided which comprises a tubular metal body having an exposed exterior surface and a generally cylindrical internal surface. The internal surface of the tubular metal body is plated with a deposit of chromium to give the section of piping a hard chromium case which resists abrasion. The deposit of chromium is applied by exposing the internal surface of the tubular metal body to an aqueous electrolyte solution at a current density and at a plating temperature sufficient to form a chromium deposit of desired thickness on the internal surface. The electrolyte solution contains an electrolyte system, preferably with a catalyst to increase the plating rate. In one embodiment of the invention, the electrolyte solution contains water, chromic acid and a sulfate component. In certain embodiments of the invention, the electrolyte solution also contains an alkyl sulphonic acid and an anion of molybdenum. The chrome plated internal surface is harder and also smoother than the prior art, providing a more wear resistant surface which is much easier to clean after pumping operations.

Additional objects, features and advantages will be apparent in the written description which follows.

### BRIEF DESCRIPTION OF THE DRAWINGS

FIG. 1 is a side, perspective view of a mobile pump truck which utilizes concrete placement booms which are treated according to the method of the invention.

FIG. 2 is a partial side view of a section of the placement boom of FIG. 1 showing the couplings used to connect various sections of piping.

FIG. 3 is a partial cross sectional view of a section of piping treated according to the method of the invention.

FIG. 4 is a simplified, schematic view of a chrome plating process according to the method of the invention.

### DETAILED DESCRIPTION OF THE INVENTION

As discussed under the “Background of the Invention”, a variety of applications exist in industry for pumping abrasive materials. Typical applications include the mining industry and the various construction industries which pump concrete. The following discussion deals primarily with an improved steel piping for use in pumping concrete, as through the extensible “booms” used in transporting concrete from a stationary or mobile rig at a job site, and to a “paste” fill system used in a mining operation. However, it will be understood by those skilled in the relevant arts that the present invention has application to other industries as well, where steel piping is utilized to transport abrasive materials or slurries.

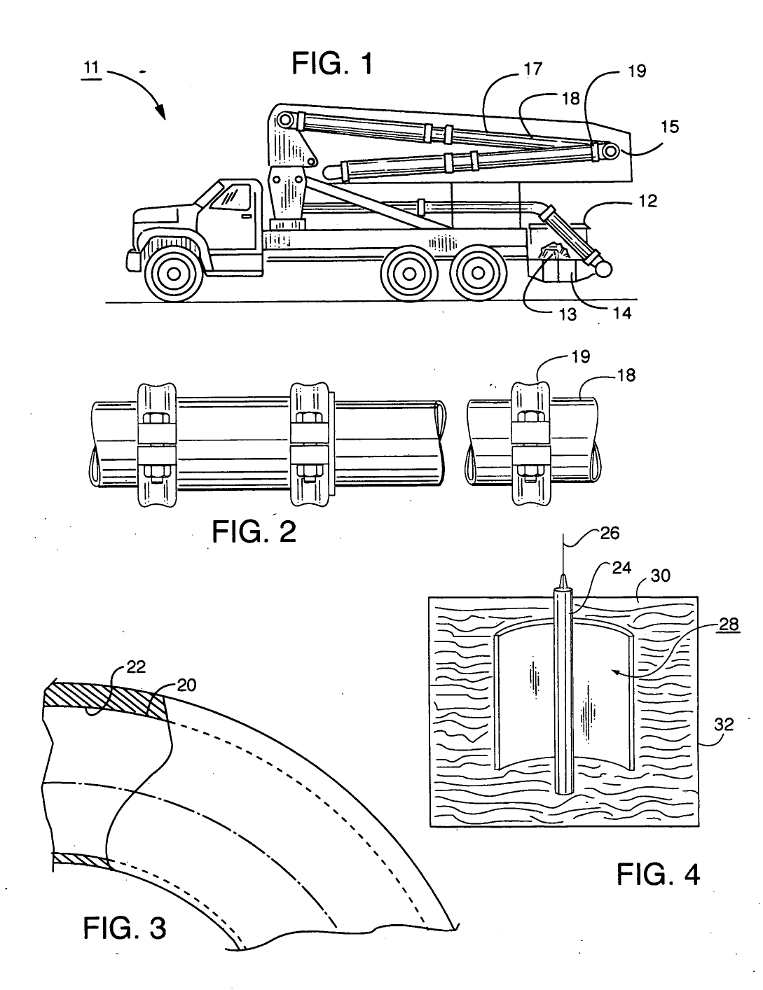

Turning to FIG. 1, there is shown a mobile concrete placement unit 11 in a location for distributing concrete within a given surrounding area. The mobile placement unit includes a supply hopper 12 within which a supply of concrete 13 is held. A concrete pump assembly 14 on unit 11 draws the concrete 13 from the hopper 12 and discharges it through a distributing line system 15 and to a discharge nozzle, not shown. The discharge line system 15 includes an extensible boom 17 which has pivoted sections for folding of the boom and line during transport. A pipe line distribution system is formed by a plurality of pipe sections 18 connected to the discharge end of the concrete pump assembly 14 and supported on the several boom sections. The several pipe sections 18 are coupled to each other through releasable couplings 19 to permit replacement of the pipe sections and include swivel end sections to accommodate the movement of the boom sections.

A partial view of a section of the piping under consideration is shown in FIG. 2. The pipe sections 18 are joined at the couplings 19. The basic pipe section 18 may, for example, be an industry standard 5 or 6 inch diameter pipe section. The pipe is formed of a suitable heavy gauge metal such as on the order of a #7 gauge ductile steel.

FIG. 3 shows a portion of a pipe section which is curved and which would be used, for example, at an elbow in a pipe system of the type under consideration. As shown in FIG. 3, the piping of the invention is a tubular member of a metal alloy having an exposed, external surface 20 and an internal, generally cylindrical surface 22. While the pipe shown in FIGS. 1-3 is a cylindrical, tubular member, it will be appreciated that other shapes, such as oval shapes, might also be utilized for specialized applications. In the method of the present invention, a chrome plating process is utilized to produce a deposit of chromium which forms a hardened case on the internal surface 22 of the metal alloy piping 18. Within the scope of the discussion which follows, “metal alloy” particularly signifies steel (iron alloys) and aluminum alloys. The chrome plating process can be a process of the type currently practiced commercially in the relevant plating industries and will generally contain an electrolyte system, preferably with a catalyst to increase the plating rate.

The section of pipe shown in FIG. 3 can also represent a turn or elbow used in the paste backfilling of a mining operation. A number of mines are installing paste fill systems at the present time to replace current sand fill techniques. However, paste fill piping systems typically exhibit extremely rapid wear. The cost to replace a prematurely worn drop shaft is often millions of dollars.

In a typical paste fill operation, a system valve at the base of a vertical pipe is closed and the entire pipe is filled with water. A plug or ball is inserted into the pipe above the water. Sufficient priming slurry to lubricate the line is added above the plug. A special bleed water valve at the base is opened to allow a controlled descent of the lubrication slurry, followed by the paste fill. The start-up water discharged from the line is pumped back to the surface. Once the start-up water has been discharged from the system, the system shut-off valve is opened. This action allows the paste fill to flow by gravity thru the remaining piping system to the stops.

A typical paste fill operation will run 24 hours a day after startup. To shut down and clean out the paste fill line, a ball is inserted into the pipe above the paste fill. This ball scrubs the pipe wall while also preventing mixing of the water with the paste. A small amount of water is also pumped above the ball to aid in cleaning. The system shut off valve is opened and the paste fill pulls the ball and water through the system.

While the above described paste fill operation is fairly basic in concept, the various materials being pumped lead to excessive wear on the pipe interior surfaces. This is partly due to the fact that operating pressures encountered can be extremely high, e.g., in excess of 4000 psi, while the material being conveyed is extremely abrasive. The method of the invention can be used to increase the useful life of piping used in paste fill operations by providing a hard chrome plated surface on the pipe interior.

The plating baths useful for purposes of the present invention will now be described. Functional hexavalent chromium plating baths containing chromic acid and sulfate as a catalyst generally permit the deposition of chromium metal on the base metal at cathode efficiencies of between about 12% and 16% at temperatures between about 52° C. to 68° C. and at current densities from about 30 to about 50 A/dm². Typical state-of-the-art chromium plating baths are described, for instance, in U.S. Pat. No. 3,745,097, issued Jul. 10, 1973 and U.S. Pat. No. 4,588,481, issued May 13, 1986. For example, a typical chromium electroplating bath in accordance with the teaching of U.S. Pat. No. 4,588,481 has the following constituents present in g/l.

TABLE 1

| | Suitable | Preferred |
|---|---|---|
| Constituent | | |
| Chromic Acid | 100-450 | 200-300 |
| Sulfate | 1-5 | 1.5-3.5 |
| Organic Sulfate Acid | 1-18 | 1.5-12 |
| Optional Constituent | | |
| Boric Acid | 0-40 | 4-30 |
| Operation Conditions | | |
| Temperature (° C.) | 45-70 | 50-60 |
| Current density (a.s.d.) | 11.6-230 | 30-100 |

The traditional chromium baths described above are useful for the purposes of the present invention and produce very bright, hard (KN₁₀₀>900) adherent, non-iridescent chromium deposit on base metals in which the plating efficiency in the process is about 22% at 77.5 a.s.d. and at a plating temperature of 55° C. The ratio of the concentration of chromic acid to sulfonate in the above described baths suitably ranges from 25 to 450, preferably 40-125, and optimally about 70. The ratio of the concentration of chromic acid to sulfate suitably ranges from 25 to 200, preferably 60-150, and optimally about 100.

While the above described prior art process as well as other traditional chrome plating techniques known to those skilled in the relevant art can be used in the practice of the invention, one particular embodiment of the plating process used in the method of the invention will now be described. In this particular process, hard chromium is deposited on the internal surface of the metal piping from an aqueous electrolyte solution containing chromic acid and a sulfate component such as sulfuric acid, namely from the classical chromium bath with CrO₃ content of about 150 to 400 grams per liter, preferably about 250 to 300 grams per liter, and an SO₄ content of about 2 to 15 grams per liter, preferably about 2 to 4 grams per liter.

The preferred base electrolyte treatment solution also includes, as one component, an alkyl sulphonic acid. Preferably, the alkyl sulphonic acid is a saturated aliphatic sulphonic acid with a maximum of two carbon atoms and a maximum of six sulphonic acid groups or their salts or halogen derivatives. Members of the above class of organic compounds include methane sulphonic acid, ethane sulphonic acid, methane disulphonic acid, 1,2-ethane disulphonic acid, salts of the above mentioned acids or halogen derivatives. Most preferably, the organic compound is methane sulphonic acid, present in the range from about 1 to 18 grams per liter, most preferably about 2 to 4 grams per liter.

In addition to the above listed components of the base electrolyte treatment solution, this particular preferred method of the invention includes the addition of an anion of molybdenum such as ammonium molybdenate to the base electrolyte solution in the range from about 10 to 100 grams per liter, most preferably about 25 to 50 grams per liter. The addition of the molybdenum anion materially changes the fundamental character of the base electrolyte treatment solution, providing a treated surface with improved wear and abrasion resistance obtainable at high current efficiency and at a useful current density.

In addition to the above listed components, the base electrolyte treatment solution can also contain other enhancement additives. For instance, the base electrolyte solution can contain boric acid or borates in the range from about 4 to 40 grams per liter, most preferably about 6 to 12 grams per liter boric acid. The addition of boric acid or borates has the effect of increasing the hardness and increasing the cracks per unit area from about 500 cracks/cm² to about 2,000 cracks/cm² or more.

Microcracks, instead of larger cracks, tend to increase the corrosion resistance of the chrome. A final surface finish can be provided of less than about 40-60 micro-inch, and in some cases less than 20 micro-inch.

The following example is intended to be illustrative of one preferred embodiment of the invention without limiting the scope thereof:

An electrolyte treatment solution is prepared having the following composition:
2-4 grams per liter methane sulphonic acid;
2-4 grams per liter sulfuric acid;
250-300 grams per liter chromic acid; and
6-12 grams per liter boric acid;
25-50 grams per liter ammonium molybdenate or other molybdenum salt producing an anion.

At a current density in the range from about 2 to 6 Amps/in ² and at a plating temperature of about 135° F., a cathode efficiency of about 18 to 22% is realized. Where about 10 to 100 grams per liter of ammonium molybdenate, preferably about 25 to 50 grams per liter, are added to the plating bath, an alloy chrome is produced with about one halfpercent molybdenum which exhibits greatly increased wear life. If pulsed D.C. current is used, about one and one half percent molybdenum is deposited.

The actual plating process can be accomplished by placing an anode through the pipe and causing current to flow from the anode to the pipe. Alternatively, as shown in FIG. 4, a traveling anode 24 approximately two feet long on a flexible cable 26 traverses up and down the pipe interior (28 in FIG. 4) to insure a more uniform plating. The pipe is itself immersed in the electrolyte solution 30 contained in the plating tank 32. Scot Industries, Inc. of Lone Star, Texas, has commercially available plating facilities of this and other types capable of plating pipes from 1-20 inch internal diameters and up to 56 feet in length. Other techniques known in the chrome plating arts may also be utilized to provide the desired plating on the pipe internal surface.

For purposes of the present invention, the internal surface of the tubular metal body is plated with a deposit of chromium to a selected thickness to give the section of piping a hard chromium case which resists abrasion. Preferably, the chromium case has a thickness in the range from about 0.001 to 0.035 inches. Most preferably, the chromium case has a thickness of about 0.010 inches. The internal surface of the tubular metal body may or may not be refined or smoothed, as by honing the internal surface, using commonly known techniques, prior to applying the deposit of chromium. In other instances, the tube may be, for example, cold drawn and directly plated without the necessity of honing. Other forming processes may be envisioned on the steel tube which would similarly refine the surface.

An invention has been provided with several advantages. The piping of the invention can be used for pumping abrasive materials such as the abrasive materials encountered in the concrete and mining industries. The chrome plating of the invention provides improved abrasion resistance while at the same time allowing for a reduced wall thickness in the piping where this is desirable. As a result, the piping of the invention may be lighter in weight than the piping of the prior art. The qualities of improved abrasion resistance, lighter weight and ease of cleaning are particular advantages achieved by the processes of the invention. For example, ordinary steel pipe has a useful service life of about 15,000 yards of concrete pumped through the piping. Hardened pipe will generally last for about 35,000 yards of concrete pumped. A pipe with its internal surface chrome plated according to the teachings of the invention was placed in an experimental test on Oct. 20, 2002. As of Jul. 21, 2003, approximately 19,640 yards of concrete had been pumped through the piping. A measurement of the chrome thickness of the plating with a Perma-scope showed that there was no appreciable wear on the internal surface of the piping.

While the invention has been shown in several of its embodiments to illustrate the principles of the invention, it is not limited thereby but is susceptible to various changes and modifications as have been suggested herein without departing from the spirit thereof.

1. A section of piping for transporting an abrasive slurry which has improved abrasion resistance and which also exhibits ease of cleaning after use, the piping comprising:
a tubular metal body having an exposed exterior surface and an internal surface, the internal surface of the tubular body being plated with a deposit of chromium to give the section of piping a hard chromium case which resists abrasion.

2. The section of piping of claim 1, wherein the chromium case has a thickness in the range from about 0.001 to 0.035 inches.

3. The section of piping of claim 2, wherein the chromium case has a thickness of approximately 0.010 inches.

4. A method of improving the abrasion resistance of a section of piping for transporting abrasive materials, the method comprising the steps of:
providing a tubular metal body of a selected length having an exposed exterior surface and a generally cylindrical internal surface;
exposing the internal surface of the tubular metal body to an electrolyte solution containing at least water, an electrolyte and a catalyst which provides an accelerated plating rate, the internal surface being exposed to the electrolyte solution at a current density and at a plating temperature sufficient to form a chromium deposit of desired thickness on the internal surface, whereby the internal surface of the tubular metal body is plated with a deposit of chromium to give the section of piping a hard chromium case which resists abrasion.

5. The method of claim 4, wherein the electrolyte solution, in addition to water, includes chromic acid and a sulfate component.

6. The method of claim 5, wherein the electrolyte solution also contains an alkyl sulphonic acid and an anion of molybdenum.

7. The method of claim 6, wherein the alkyl sulphonic acid is a saturated aliphatic sulphonic acid having a maximum of two carbon atoms and a maximum of six sulphonic acid groups or their salts or halogen derivatives thereon.

8. The method of claim 7, further characterized in that the cathode efficiency of the process is greater than about 18%.

9. The method of claim 8, wherein the current applied to the aqueous electrolyte bath is applied as pulsed direct current to provide an alloy chromium deposit having at least about 1.5% molybdenum deposited.
